(19) United States
(12) Patent Application Publication
(10) Pub. No.: US 2020/0192158 A1
(43) Pub. Date: Jun. 18, 2020

(54) ELECTRONIC DEVICE AND FINGERPRINT IDENTIFICATION AND UNIFORM LIGHT STRUCTURE THEREOF

(71) Applicant: CHICONY ELECTRONICS CO., LTD., New Taipei City (TW)

(72) Inventors: CHENG-CHUNG CHANG, New Taipei City (TW); CHIH-LIANG LIAO, New Taipei City (TW)

(21) Appl. No.: 16/562,790

(22) Filed: Sep. 6, 2019

(30) Foreign Application Priority Data
Dec. 18, 2018 (TW) 107145750

(51) Int. Cl. G02F 1/1335; G06K 9/00

(52) U.S. Cl. CPC G02F 1/133605; G06K 9/0004; G02F 1/133603

(57) ABSTRACT

A fingerprint identification and uniform light structure is applied to an electronic device which includes a display screen. The fingerprint identification and uniform light structure includes a backlight plate, a plurality of light emitting units, a semi-transparent reflective filter and a fingerprint photography module. The backlight plate is located under the display screen, and the backlight plate includes a hole. The plurality of light emitting units are located on one side of the backlight plate, and the side is toward the display screen. The semi-transparent reflective filter is located in the hole. The fingerprint photography module is located under the filter.

### BACKGROUND OF THE INVENTION

### 1. Field of the Invention

The present invention relates to a fingerprint identification and uniform light structure; more particularly, the present invention relates to a fingerprint identification and uniform light structure which can be installed under a display screen without affecting the display of an image on the display screen.

### 2. Description of the Related Art

Some full screen smart phones on the market have a fingerprint identification function; in the structure of that kind of smart phone, the liquid crystal display screen directly covers the fingerprint sensor, and the light-emitting diodes and the fingerprint sensor are located at the same height; therefore, when the user's fingerprint presses the liquid crystal display screen, the fingerprint sensor under the liquid crystal display screen can identify the user's fingerprint, and the light-emitting diodes can emit light to the liquid crystal display screen for displaying an image on the screen.

However, since the fingerprint sensor is installed under the liquid crystal display screen, the fingerprint sensor will interfere with the light emitted by the light-emitting diodes which are located under the liquid crystal display screen; therefore, the fingerprint sensor will generate a dark spot on the image displayed by the liquid crystal display screen, which will seriously affect the quality of the image viewed by the user.

Therefore, there is a need to provide a new fingerprint identification and uniform light structure which can be installed under the display screen without affecting the display of the image on the display screen.

### SUMMARY OF THE INVENTION

It is an object of the present invention to provide a fingerprint identification and uniform light structure which can be installed under the display screen without affecting the display of the image on the display screen.

To achieve the abovementioned object, the fingerprint identification and uniform light structure of the present invention is applied to an electronic device. The electronic device includes a display screen. The fingerprint identification and uniform light structure includes a backlight plate, a plurality of light emitting units, a semi-transparent reflective filter and a fingerprint photography module. The backlight plate is located under the display screen. The backlight plate includes a hole. The plurality of light emitting units are located on one side of the backlight plate, and the side of the backlight plate is toward the display screen. The semi-transparent reflective filter is located in the hole. The fingerprint photography module is located under the semi-transparent reflective filter.

According to one embodiment of the present invention, the semi-transparent reflective filter further includes a bottom board and a plating layer. The plating layer is located on one side of the bottom board, and the side of the bottom board is toward the backlight plate.

According to one embodiment of the present invention, a surface of the plating layer is shaped as a zigzag shape or a stair-shape.

According to one embodiment of the present invention, the plurality of light emitting units are symmetrically located on the backlight plate.

According to one embodiment of the present invention, a part of the light emitting units are symmetrically located on the backlight plate, and the other part of the light emitting units surround the hole and are symmetrical to one another.

According to one embodiment of the present invention, the semi-transparent reflective filter is made of glass, polycarbonate or polymethyl methacrylate.

Another object of the present invention is to provide an electronic device which has a fingerprint identification and uniform light structure that can be installed under the display screen without affecting the display of the image on the display screen.

To achieve the abovementioned object, the electronic device of the present invention includes a display screen and a fingerprint identification and uniform light structure. The fingerprint identification and uniform light structure includes a backlight plate, a plurality of light emitting units, a semi-transparent reflective filter and a fingerprint photography module. The backlight plate is located under the display screen. The backlight plate includes a hole. The plurality of light emitting units is located on one side of the backlight plate, and the side is toward the display screen. The semi-transparent reflective filter is located in the hole. The fingerprint photography module is located under the semi-transparent reflective filter.

### BRIEF DESCRIPTION OF THE DRAWINGS

FIG. 1 illustrates a schematic drawing of the electronic device in the first embodiment of the present invention.

FIG. 2 illustrates a schematic drawing of the fingerprint identification and uniform light structure installed under the display screen in the first embodiment of the present invention.

FIG. 3 illustrates a sectional view of the electronic device in the first embodiment of the present invention.

FIG. 4 illustrates a schematic drawing of the semi-transparent reflective filter in the first embodiment of the present invention.

FIG. 5 illustrates a schematic drawing of the other type of the semi-transparent reflective filter in the first embodiment of the present invention.

FIG. 6 illustrates a schematic drawing of the backlight plate and the light emitting unit in the second embodiment of the present invention.

### DETAILED DESCRIPTION OF THE PREFERRED EMBODIMENT

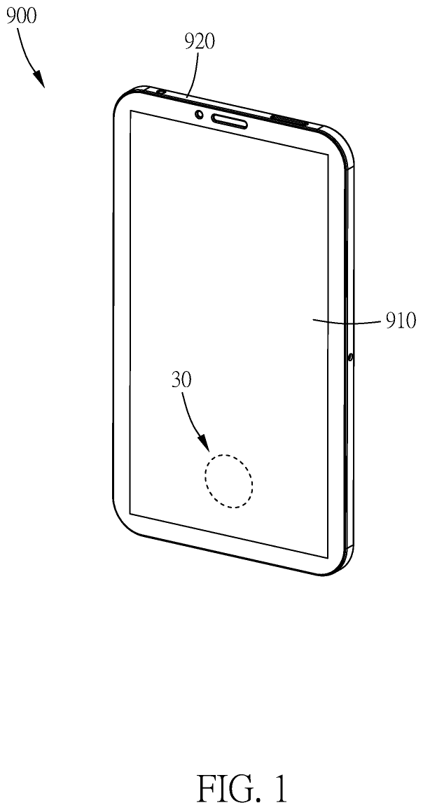

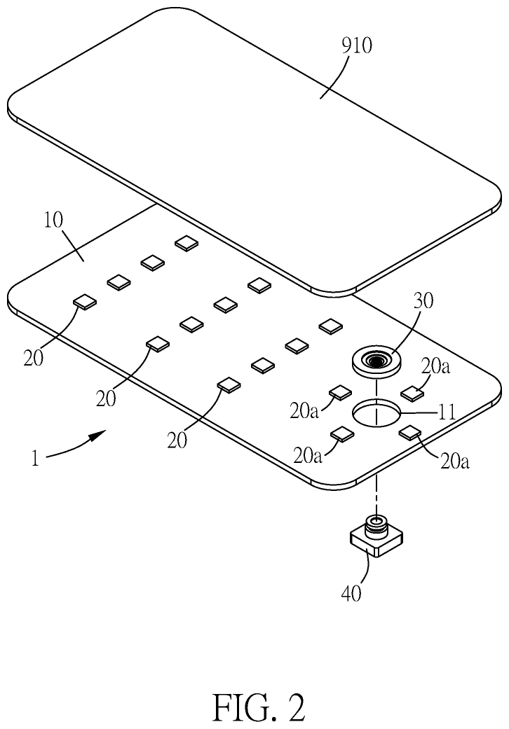

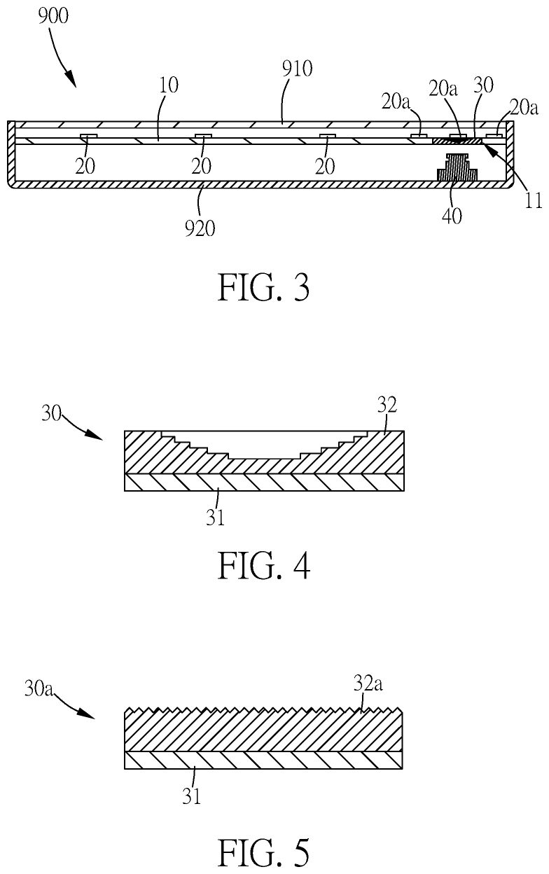

Please refer to FIG. 1 to FIG. 5, which illustrate the electronic device and the fingerprint identification and uniform light structure in the first embodiment of the present invention. FIG. 1 illustrates a schematic drawing of the electronic device in the first embodiment of the present invention. FIG. 2 illustrates a schematic drawing of the fingerprint identification and uniform light structure installed under the display screen in the first embodiment of the present invention. FIG. 3 illustrates a sectional view of the electronic device in the first embodiment of the present invention. FIG. 4 illustrates a schematic drawing of the semi-transparent reflective filter in the first embodiment of the present invention. FIG. 5 illustrates a schematic drawing of the other type of the semi-transparent reflective filter in the first embodiment of the present invention.

In the first embodiment of the present invention, as shown in FIG. 1 and FIG. 2, the electronic device 900 is a full screen smart phone. The electronic device 900 includes a display screen 910, an electronic device case 920 and a fingerprint identification and uniform light structure 1. The display screen 910 is a thin film transistor liquid crystal display (TFT-LCD) screen for displaying the image to the user. The electronic device case 920 is connected to the display screen 910. A containing space is formed between the electronic device case 920 and the display screen 910 for containing the electronic components in the electronic device 900.

In the first embodiment of the present invention, as shown in FIG. 2 and FIG. 3, the fingerprint identification and uniform light structure 1 is used for identifying a fingerprint and for providing uniform light to the display screen 910 such that no dark spot appears on the display screen 910. The fingerprint identification and uniform light structure 1 includes a backlight plate 10, sixteen light emitting units 20, 20a, a semi-transparent reflective filter 30 and a fingerprint photography module 40. The backlight plate 10 is a direct back-lit structure panel located under the display screen 910. The backlight plate 10 includes a hole 11. The backlight plate 10 is used for coordinating with the sixteen light emitting units 20, 20a to project light to the display screen 910 such that the display screen 910 can display an image.

In the first embodiment of the present invention, the sixteen light emitting units 20, 20a are light-emitting diodes (LED). The sixteen light emitting units 20, 20a are located on one side of the backlight plate 10, and the side of the backlight plate 10 is toward the display screen 910. Twelve light emitting units 20 are symmetrically located on the backlight plate 10, and the other four light emitting units 20a surround the hole 11 and are symmetrical to one another on the backlight plate 10. The sixteen light emitting units 20, 20a are used for emitting light to the display screen 910, and the backlight plate 10 can also reflect light to the display screen 910; thus, the display screen 910 can obtain enough light to display the image. However, the amount of the light emitting units 20, 20a is not limited to sixteen, for the amount can be changed according to the design requirements, and the positions of the light emitting units 20 are not limited to be symmetrical, for the positions can be changed to be asymmetrical.

In the first embodiment of the present invention, as shown in FIG. 2 to FIG. 4, the semi-transparent reflective filter 30 is made of glass, polycarbonate or polymethyl methacrylate. The semi-transparent reflective filter 30 is located in the hole 11, and the overall height of the semi-transparent reflective filter 30 is not higher than the hole 11. The semi-transparent reflective filter 30 includes a bottom board 31 and a plating layer 32. The plating layer 32 is formed via the nano printing technology and located on one side of the bottom board 31, and the side of the bottom board 31 is toward the backlight plate 10. The surface of the plating layer 32 is shaped as a stair-shape, the size of the plating layer 32 can be changed according to the distance and view of the lens field of the fingerprint photography module 40, and the size of the plating layer 32 can be changed according to the application purpose. The non-planar shape of the plating layer 32 of the semi-transparent reflective filter 30 allows a part of the light emitted by each of the light emitting units 20a around the hole 11 to pass through the semi-transparent reflective filter 30 and also allows the other part of the light to be reflected to the display screen 910; thus, the function of allowing a portion of the light to pass and the function of reflecting a portion of the light can both be achieved. However, the surface of the plating layer is not limited to the stair-shape, as shown in the semi-transparent reflective filter 30a of FIG. 5; the surface of the plating layer 32a can also be shaped as a zigzag shape, and the zigzag-shaped surface can also achieve the function of allowing a portion of the light to pass and the function of reflecting a portion of the light.

In the first embodiment of the present invention, as shown in FIG. 1 to FIG. 3, the fingerprint photography module 40 is a photographic lens with a fingerprint identification function and is located under the semi-transparent reflective filter 30. When the user's finger presses on a position of the display screen 910 and that position is corresponded to the position of the semi-transparent reflective filter 30, the fingerprint photography module 40 under the semi-transparent reflective filter 30 will capture the user's fingerprint for fingerprint identification.

When the user wants to use the fingerprint identification and uniform light structure 1 to identify the fingerprint, as shown in FIG. 1, the user's finger can press on a position on the display screen 910, and that position is corresponded to the position of the semi-transparent reflective filter 30; at this moment, as shown in FIG. 2 and FIG. 3, the light of the light emitting unit 20a emitted toward the display screen 910 passes through the display screen 910 and touches the fingerprint, is reflected to the semi-transparent reflective filter 30, passes through the semi-transparent reflective filter 30 and enters the photographic lens of the fingerprint photography module 40, whereby the fingerprint photography module 40 can obtain the light reflected from the fingerprint to obtain the fingerprint image, such that the fingerprint photography module 40 can identify the fingerprint.

When the user wants to view the image displayed by the display screen 910, a part of the light emitted by the light emitting units 20 will be directly emitted toward the display screen 910, and the other part of the light emitted by the light emitting units 20 will be emitted toward the backlight plate 10 and reflected to the display screen 910; also, a part of the light of the light emitting units 20a will be directly emitted toward the display screen 910, and the other part of light of the light emitting units 20a will be emitted toward the backlight plate 10 or the semi-transparent reflective filter 30 and be reflected to the display screen 910; therefore, the display screen 910 will obtain light that is uniform and is also sufficient for display of the image. Because the fingerprint photography module 40 is located under the semi-transparent reflective filter 30, the fingerprint photography module 40 will not interfere with the light emitted by the light emitting unit 20a or the light reflected by the backlight plate 10 or the semi-transparent reflective filter 30, such that the image displayed by the display screen 910 will not be affected.

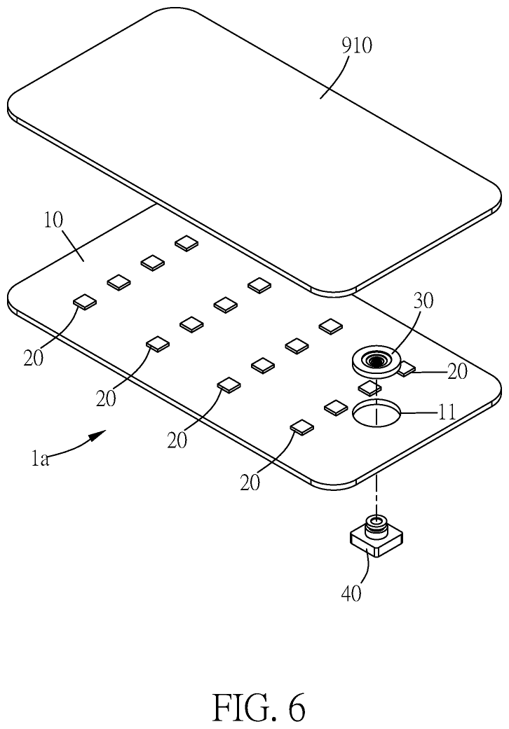

Please refer to FIG. 6, which illustrates the fingerprint identification and uniform light structure in the second embodiment of the present invention. FIG. 6 illustrates a schematic drawing of the backlight plate and the light emitting unit in the second embodiment of the present invention.

As shown in FIG. 6, the difference between the second embodiment and the first embodiment is that, in the second embodiment, the sixteen light emitting units 20 of the fingerprint identification and uniform light structure 1a are symmetrically located on the backlight plate 10, and the light emitting units 20 do not surround the hole 11. In the second embodiment, the light of the light emitting unit 20 is directly emitted toward the display screen 910 or toward the backlight plate 10 or the semi-transparent reflective filter 30 and reflected to the display screen 910; therefore, the display screen 910 can obtain enough light to display the image, and the fingerprint photography module 40 will not interfere with the light emitted by the light emitting unit 20 or the light reflected by the backlight plate 10 or the semi-transparent reflective filter 30, such that the image of the display screen 910 will not be affected.

Via the fingerprint identification and uniform light structure of the present invention, the fingerprint identification and uniform light structure can have a simple structure which does not increase the thickness, has a low installation cost, and is easy to assemble and produce and thus is suitable for mass production. The fingerprint photography module will not interfere with the light emitted by the light emitting units or the light reflected by the backlight plate or the semi-transparent reflective filter, such that the image displayed by the display screen will not be affected, and the fingerprint photography module can still identify the fingerprint.

What is claimed is:

1. A fingerprint identification and uniform light structure, applied to an electronic device, wherein the electronic device comprises a display screen, the fingerprint identification and uniform light structure comprising:
a backlight plate, located under the display screen, wherein the backlight plate comprises a hole;
a plurality of light emitting units, located on one side of the backlight plate, wherein the side of the backlight plate is toward the display screen;
a semi-transparent reflective filter, located in the hole; and
a fingerprint photography module, located under the semi-transparent reflective filter.

2. The fingerprint identification and uniform light structure as claimed in claim 1, wherein the semi-transparent reflective filter further comprises a bottom board and a plating layer; the plating layer is located on one side of the bottom board, and the side of the bottom board is toward the backlight plate.

3. The fingerprint identification and uniform light structure as claimed in claim 2, wherein a surface of the plating layer is shaped as a zigzag shape or a stair-shape.

4. The fingerprint identification and uniform light structure as claimed in claim 3, wherein the plurality of light emitting units are symmetrically located on the backlight plate.

5. The fingerprint identification and uniform light structure as claimed in claim 4, wherein a part of the light emitting units are symmetrically located on the backlight plate and the other part of the light emitting units surround the hole and are symmetrical to one another.

6. The fingerprint identification and uniform light structure as claimed in claim 5, wherein the semi-transparent reflective filter is made of glass, polycarbonate or polymethyl methacrylate.

7. An electronic device, comprising:
a display screen; and
a fingerprint identification and uniform light structure, comprising:
a backlight plate, located under the display screen, wherein the backlight plate comprises a hole;
a plurality of light emitting units, located on one side of the backlight plate, wherein the side of the backlight plate is toward the display screen;
a semi-transparent reflective filter, located in the hole; and
a fingerprint photography module, located under the semi-transparent reflective filter.

8. The electronic device as claimed in claim 7, wherein the semi-transparent reflective filter further comprises a bottom board and a plating layer; the plating layer is located on one side of the bottom board, and the side of the bottom board is toward the backlight plate.

9. The electronic device as claimed in claim 8, wherein a surface of the plating layer is shaped as a zigzag shape or a stair-shape.

10. The electronic device as claimed in claim 9, wherein the plurality of light emitting units are symmetrically located on the backlight plate.

11. The electronic device as claimed in claim 10, wherein a part of the light emitting units are symmetrically located on the backlight plate and the other part of the light emitting units surround the hole and are symmetrical to one another.

12. The electronic device as claimed in claim 11, wherein the semi-transparent reflective filter is made of glass, polycarbonate or polymethyl methacrylate.
